(19) United States
(12) Patent Application Publication
(10) Pub. No.: US 2026/0189839 A1
(43) Pub. Date: Jul. 2, 2026

(54) EARPHONE

(71) Applicant: Merry Electronics(Shenzhen) Co., Ltd., ShenZhen (CN)

(72) Inventors: Hung-Wei Chen, Taichung (TW); Chun-Hung Chang, Taichung (TW); Chih-Hung Liu, Taichung (TW); Po Hsun Sung, Taichung (TW)

(73) Assignee: Merry Electronics(Shenzhen) Co., Ltd., ShenZhen (CN)

(21) Appl. No.: 19/044,643

(22) Filed: Feb. 4, 2025

(30) Foreign Application Priority Data
Dec. 27, 2024 (TW) 113151066

(51) Int. Cl. H04R 1/10

(52) U.S. Cl. CPC H04R 1/1016; H04R 1/105; H04R 1/1066; H04R 2460/11

(57) ABSTRACT

An earphone adapted for being worn on an ear is provided. The earphone includes an acoustical component and a wearing component. The wearing component is connected to the acoustical component, and the acoustical component and the wearing component together form an acoustic chamber. The wearing component includes a positioning portion, a sound output surface and an acoustic sound outlet. The acoustic sound outlet is located on the sound output surface and connected to the acoustic chamber. When the earphone is worn on the ear, the positioning portion extends into the ear and abuts against a cavum conchae of the ear, and the sound output surface faces an ear canal of the ear.

### CROSS-REFERENCE TO RELATED APPLICATION

This application claims the priority benefit of Taiwan application serial no. 113151066 filed on Dec. 27, 2024. The entirety of the above-mentioned patent application is hereby incorporated by reference herein and made a part of this specification.

### BACKGROUND

### Technical Field

The disclosure relates to an earphone.

### Description of Related Art

The known earphone includes the open-type earphone. The feature of the open-type earphone is that the earphone do not completely cover or block the entrance of the ear canal, maintaining a larger distance between the sound outlet of the earphone and the ear canal. There is a larger gap between the open-type earphone and the entrance of the ear canal, allowing the user to hear the external sound through the gap. Limited by the structure of open-type earphones, when worn on ears of different shapes, the distance between the sound outlet of the earphone and the ear canal varies, causing inconsistent audio experiences for each user. Moreover, the larger distance between the sound outlet of the earphone and the ear canal may cause greater attenuation of

the signal energy played by the open-type earphone when entering the ear canal, resulting in reduced audio performance of the open-type earphone.

### SUMMARY

The disclosure provides an earphone that is stably worn on the ear and has a better audio experience.

The earphone of the disclosure is adapted to be worn on an ear. The earphone includes an acoustical component and a wearing component. The wearing component is connected to the acoustical component, and the acoustical component and the wearing component jointly form an acoustic chamber. The wearing component includes a positioning portion, a sound output surface, and an acoustic sound outlet. The acoustic sound outlet is located on the sound output surface and communicated with the acoustic chamber. When the earphone is worn on the ear, the positioning portion extends into the ear and abuts against a cavum conchae of the ear, and the sound output surface faces an ear canal of the ear.

Based on the above, when the earphone of the disclosure is worn on the ear, the wearing component of the earphone extends into the ear, causing the positioning portion of the wearing component to abut against the cavum conchae of the ear. The wearing component is stably connected to the ear, thereby increasing the audio experience of the earphone. The sound output surface of the wearing component faces an ear canal of the ear, and the acoustic sound outlet of the earphone is located on the sound output surface, thereby allowing the acoustic sound outlet to be closer to the ear canal. increasing the audio performance of the earphone.

### BRIEF DESCRIPTION OF THE DRAWINGS

FIG. 1 is a schematic view of an earphone according to an embodiment of the disclosure worn on an ear.

FIG. 2 is a cross-sectional view of the earphone of FIG. 1 worn on the ear.

FIG. 3 is a schematic view of the earphone of FIG. 1.

FIG. 4 is a schematic view of the earphone of FIG. 3 from another angle.

FIG. 5 is a cross-sectional view of the earphone of FIG. 3.

FIG. 6 is an exploded view of the earphone of FIG. 3.

FIG. 7 is a schematic view of an earphone according to another embodiment of the disclosure.

FIG. 8 is a schematic view of the earphone of FIG. 7 from another angle.

### DESCRIPTION OF THE EMBODIMENTS

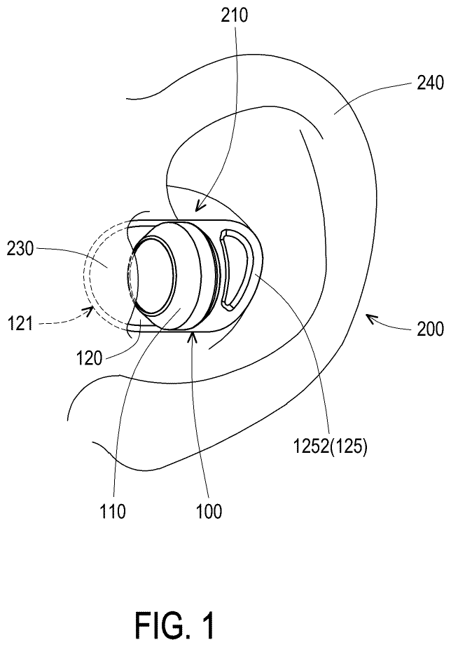

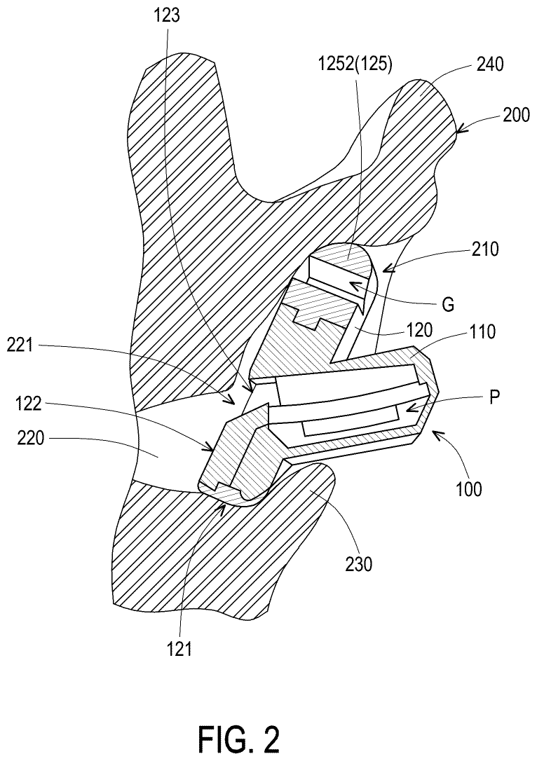

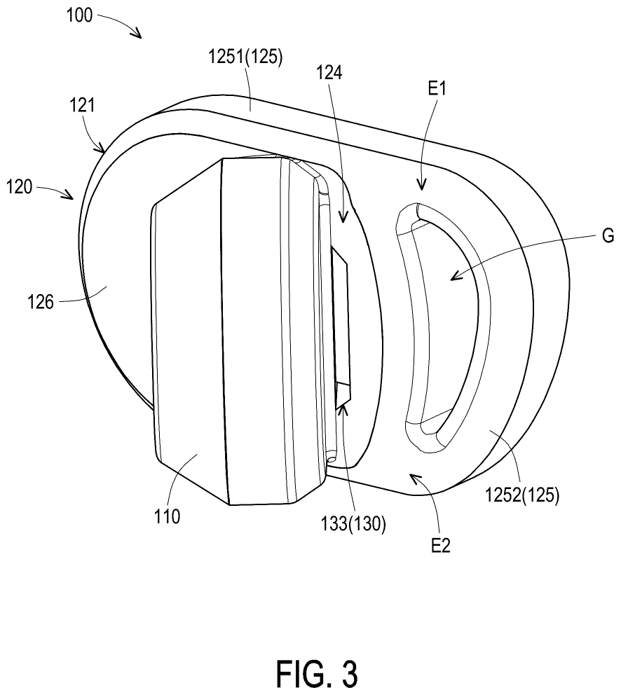

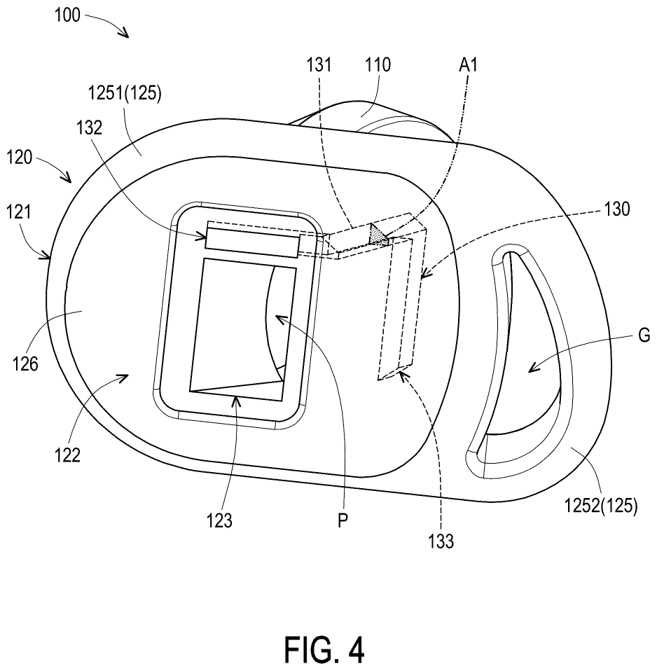

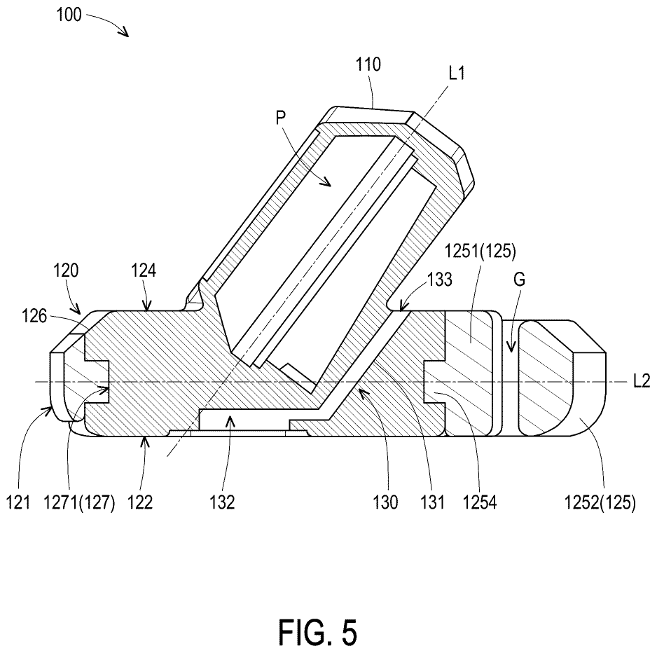

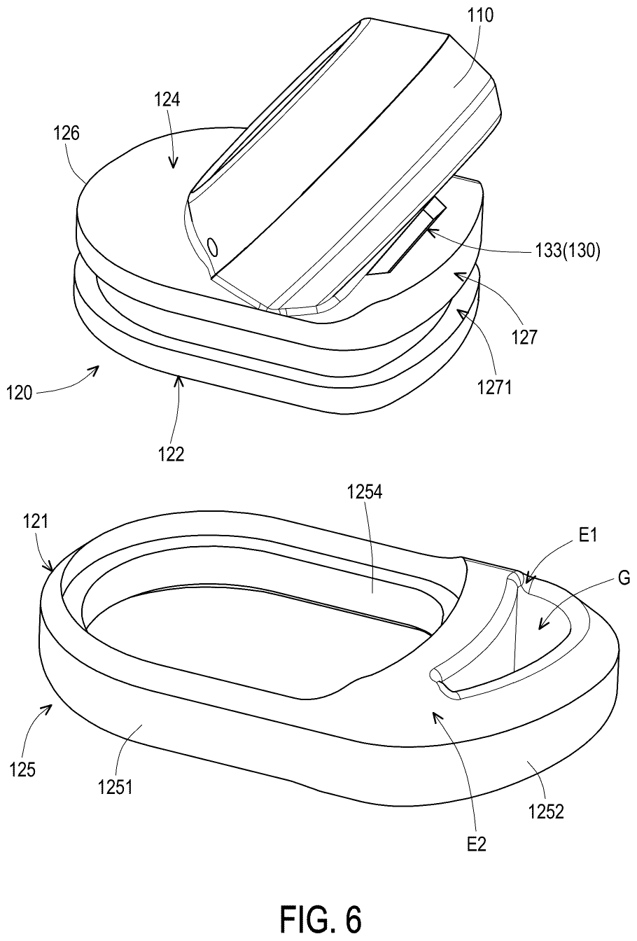

FIG. 1 is a schematic view of an earphone according to an embodiment of the disclosure worn on an ear. FIG. 2 is a cross-sectional view of the earphone of FIG. 1 worn on the ear. FIG. 3 is a schematic view of the earphone of FIG. 1. FIG. 4 is a schematic view of the earphone of FIG. 3 from another angle. FIG. 5 is a cross-sectional view of the earphone of FIG. 3. FIG. 6 is an exploded view of the earphone of FIG. 3. Please refer to FIG. 1 to FIG. 6 at the same time, the earphone 100 may be worn on an ear 200. The earphone 100 includes an acoustical component 110 and a wearing component 120. The wearing component 120 is connected to the acoustical component 110. The acoustical component 110 and the wearing component 120 jointly form an acoustic chamber P. The wearing component 120 includes a positioning portion 121, a sound output surface 122, and an acoustic sound outlet 123. The acoustic sound outlet 123 is located on the sound output surface 122 and is communicated with the acoustic chamber P. The earphone 100 of this embodiment is, for instance, an open-type wireless earphone, but not limited thereto. A plurality of acoustic elements and A plurality of electronic components (not shown) may be disposed in the acoustic chamber P.

When the earphone 100 is worn on the ear 200, the positioning portion 121 inserts into the ear 200 and abuts against a cavum conchae 210 of the ear 200, and the sound output surface 122 faces an ear canal 220 of the ear 200. Since the wearing component 120 of the earphone 100 inserts into the cavum conchae 210 of the ear 200, the sound output surface 122 of the wearing component 120 is closer to an ear canal inlet 221 of the ear canal 220, and the acoustic sound outlet 123 on the sound output surface 122 is closer to the ear canal inlet 221. The earphone 100, through the positioning portion 121, connects more stably to ears 200 of different ear shapes, and shortens a distance between the sound output surface 122 (the acoustic sound outlet 123) and the ear canal 220, thereby reducing the degree of the signal energy attenuation transmitted by the earphone 100 into the ear canal 220, and increasing the audio experience and the audio performance of the earphone 100.

The earphone 100 of this embodiment further includes an atmosphere sound channel 130. The atmosphere sound channel 130 is disposed in the wearing component 120, but not limited thereto. The atmosphere sound channel 130 includes a channel body 131, an atmosphere sound outlet 132, and an atmosphere sound inlet 133. The atmosphere sound outlet 132 and at least a portion of the atmosphere sound inlet 133 are communicated with the channel body 131, and the atmosphere sound outlet 132 is located on the sound output surface 122. The external sound (i.e., the atmosphere sound) is passed through the atmosphere sound inlet 133 to enter the channel body 131, and enter the ear 200 from the atmosphere sound outlet 132. Thereby, the earphone 100 still transmits the atmosphere sound to the ear canal 220 through the atmosphere sound channel 130 while covering most of the cavum conchae 210. Thereby, the ratio of the audio output from the acoustic sound outlet 123 to the atmosphere sound is more stable, and is not affected by the ear shape of the ear 200. In an embodiment not shown, the atmosphere sound channel 130 may be a path of the specific dimension formed between the earphone 100 and the ear 200 when the earphone 100 is worn on the ear 200, or a channel formed by other ways.

As shown in FIG. 2 to FIG. 5, the wearing component 120 includes a sound input surface 124. An extension axis L1 of the acoustical component 110 is different from an extension axis L2 of the wearing component 120, causing the acoustical component 110 to be inclinedly connected to the sound input surface 124 of the wearing component 120, but not limited thereto. The atmosphere sound channel 130 includes an atmosphere sound inlet 133. At least a portion of the atmosphere sound inlet 133 is communicated with the channel body 131 and located on the sound input surface 124. The sound input surface 124 of this embodiment is opposite to the sound output surface 122, the sound input surface 124 is a top surface of the wearing component 120, and the sound output surface 122 is a bottom surface of the wearing component 120, but not limited thereto. When the earphone 100 is worn on the ear 200, the sound input surface 124 faces towards the external environment, and the sound output surface 122 faces towards the ear canal inlet 221.

In this embodiment, when the earphone 100 is worn on the ear 200, a gap between the wearing component 120 and the cavum conchae 210 is smaller than an area of a cross section A1 of the channel body 131 of the atmosphere sound channel 130 (i.e., the cross-sectional area of the channel body 131), to ensure that atmosphere sound is transmitted through the atmosphere sound channel 130. The channel body 131 of this embodiment is inclinedly disposed on the wearing component 120 along a direction parallel to the extension axis L1, but not limited thereto. In an embodiment not shown, the channel body 131 may be disposed on the wearing component 120 along a direction perpendicular to the extension axis L2. That is, the channel body 131 may be extended vertically.

The shape of the cross section A1 of the channel body 131 of this embodiment, the shape of the atmosphere sound inlet 133, and the shape of the atmosphere sound outlet 132 are different from each other, but not limited thereto. The shape of the cross section A1 is a trapezoid, the shape of the atmosphere sound inlet 133 is an isosceles trapezoid, and the shape of the atmosphere sound outlet 132 is a rectangle. In an embodiment not shown, the shapes of the cross section A1, the atmosphere sound inlet 133, and the atmosphere sound outlet 132 may be any polygon or circular shape. The shapes of the cross section A1, the atmosphere sound inlet 133, and the atmosphere sound outlet 132 may be the same.

An area of the acoustic sound outlet 123 is greater than or equal to an area of the atmosphere sound outlet 132. The cross-sectional area of the channel body 131 (the area of the cross section A1) is less than or equal to an area of the atmosphere sound inlet 133, and less than or equal to the area of the atmosphere sound outlet 132, but not limited thereto. In this embodiment, the area of the acoustic sound outlet 123 is greater than the area of the atmosphere sound outlet 132, the cross-sectional area of the channel body 131 is less than the area of the atmosphere sound inlet 133 and less than the area of the atmosphere sound outlet 132. A portion of the atmosphere sound inlet 133 is communicated with the channel body 131.

As shown in FIG. 1, FIG. 2 and FIG. 5, since the extension axis L1 of the acoustical component 110 is different from the extension axis L2 of the wearing component 120, an orthographic projection of the acoustical component 110 to the wearing component 120 covers the atmosphere sound inlet 133. When the earphone 100 is worn on the ear 200, the inclinedly disposed acoustical component 110 blocks the external wind from entering the atmosphere sound channel 130, thereby maintaining the good audio experience for the earphone 100.

As shown in FIG. 6, the wearing component 120 includes a support structure 125 and a wearing body 126 connected to each other. The earphone 100 is connected to the ear 200 through the support structure 125. The material of the support structure 125 may be an elastic material, but not limited thereto. The wearing body 126 includes the sound output surface 122, the sound input surface 124, and a connecting surface 127. The connecting surface 127 is connected to the sound output surface 122 and the sound input surface 124, and is located between the sound output surface 122 and the sound input surface 124. The connecting surface 127 is a side surface of the wearing body 126, but not limited thereto. The connecting surface 127 includes a slot 1271, and the support structure 125 includes a protrusion 1254. The protrusion 1254 is engaged with the slot 1271, thereby connecting the support structure 125 to the connecting surface 127 of the wearing body 126. The acoustical component 110 is connected to the wearing body 126, forming an acoustic chamber P together with the wearing body 126. The atmosphere sound channel 130 is located in the wearing body 126, but not limited thereto. In an embodiment not shown, the atmosphere sound channel 130 may be disposed between the wearing body 126 and the support structure 125.

The support structure 125 includes a first portion 1251 and a second portion 1252. The protrusion 1254 is located on the first portion 1251, and the first portion 1251 is connected to the wearing body 126. The positioning portion 121 is located on the first portion 1251 of the support structure 125. The shape of the positioning portion 121 is an arc shape, but not limited thereto. The second portion 1252 includes two opposite ends E1, E2. The two ends E1, E2 are connected to the first portion 1251. There is a hollow structure G between the second portion 1252 and the first portion 1251. The first portion 1251 and the second portion 1252 are, for example, integrally formed, but not limited thereto.

As shown in FIG. 1 and FIG. 2, when the earphone 100 is worn on the ear 200, the positioning portion 121 extends into the cavum conchae 210, and a tragus 230 of the ear 200 covers the positioning portion 121. The second portion 1252 of the support structure 125 abuts against the cavum conchae 210, and the earphone 100 is stably connected to the ear 200 through the positioning portion 121 and the second portion 1252. Since the hollow structure G between the second portion 1252 and the first portion 1251, the second portion 1252 may be deformed by the pressure from the cavum conchae 210, allowing the second portion 1252 to adapt to ears 200 of different shapes. Thereby, the earphone 100 may be worn on ears 200 of different shapes, increasing the convenience of use of the earphone 100.

The structures of the positioning portion 121 and the second portion 1252 are not limited thereto. In an embodiment not shown, the structure of the positioning portion 121 may be the same as that of the second portion 1252, meaning that there may be a hollow structure G between the positioning portion 121 and the first portion 1251. In an embodiment not shown, the second portion 1252 may be the arc shaped, having the same structure as the positioning portion 121.

The known earphone is limited by the structure, such that when the earphone is connected to the ear, the distance between the position of the sound inlet of the earphone and the ear canal inlet 221 (shown in FIG. 2) is relatively far (for example, the distance is 10 millimeters), leading to the poor audio performance of the earphone. The earphone 100 of this embodiment, through the positioning portion 121 extending into the cavum conchae 210, makes the distance between the acoustic sound outlet 123 and the atmosphere sound outlet 132 and the ear canal inlet 221 closer, for example, the distance may be less than 10 millimeters. In the sound pressure test, within the range of 100 Hertz (Hz) to 3000 Hz, the sound pressure of the earphone 100 of this embodiment is 10 decibels (dB) higher than that of known earphone, and the earphone 100 of this embodiment has the better audio performance.

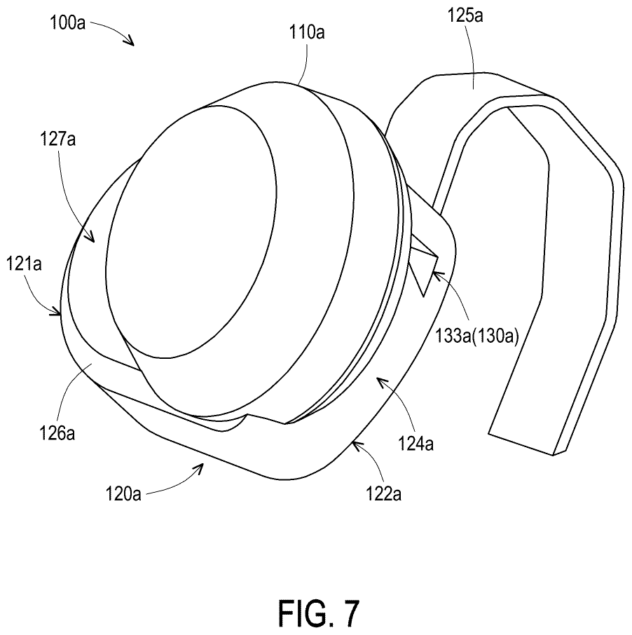

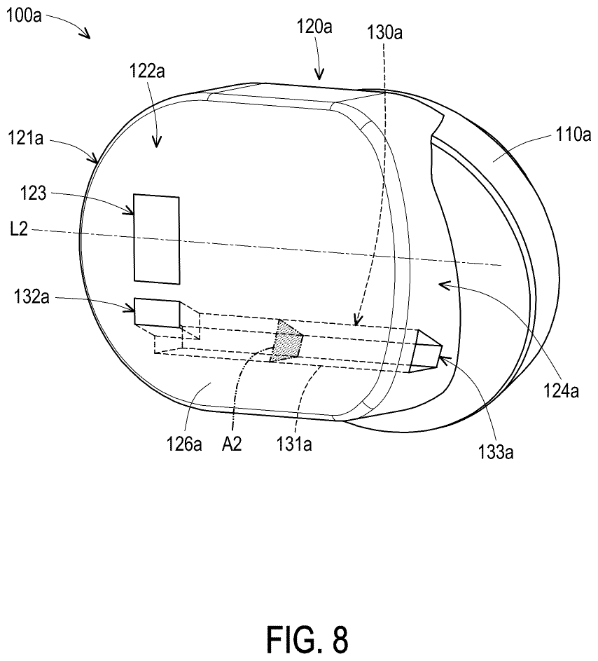

FIG. 7 is a schematic view of an earphone according to another embodiment of the disclosure. FIG. 8 is a schematic view of the earphone of FIG. 7 from another angle. the support structure 125a is omitted in FIG. 8. Please refer to FIG. 4, FIG. 7 and FIG. 8 at the same time, the earphone 100a of this embodiment is similar to the previous embodiment. The difference between the two is that in this embodiment, the sound input surface 124a of the wearing body 126a of the wearing component 120a is connected to the sound output surface 122a and the connecting surface 127a, and the connecting surface 127a is connected to the acoustical component 110a. The positioning portion 121a of the wearing component 120a is located on the wearing body 126a. When the earphone 100a is connected to the ear 200, the support structure 125a is connected to the wearing body 126a and a helix 240 (shown in FIG. 1) of the ear 200. The support structure 125a is, for example, an ear clip, but not limited thereto.

The connecting surface 127a of the wearing component 120a is relative to the sound output surface 122a, and is the top surface of the wearing component 120a. The sound input surface 124a is located between the connecting surface 127a and the sound output surface 122, and is the side surface of the wearing component 120a. The channel body 131a of the atmosphere sound channel 130a extends in the direction parallel to the extension axis L2 of the wearing component 120a. That is, the channel body 131a is extended horizontally. The shape of the cross section A2 of the channel body 131a is the same as the shape of the atmosphere sound inlet 133a, but not limited thereto. The area of the atmosphere sound inlet 133a is equal to the cross-sectional area of the channel body 131a (i.e., the area of the cross section A2), and is larger than the area of the atmosphere sound outlet 132a. The earphone 100a of this embodiment has the same effects as the previous embodiment, and is not repeated herein.

In summary, when the earphone of the disclosure is worn on the ear, the wearing component of the earphone extends into the ear, causing the positioning portion of the wearing component to abut against the cavum conchae of the ear. The wearing component is stably connected to the ear, thereby increasing the audio experience of the earphone. The sound output surface of the wearing component faces an ear canal of the ear, and the acoustic sound outlet of the earphone is located on the sound output surface, thereby allowing the acoustic sound outlet to be closer to the ear canal, increasing the audio performance of the earphone.

What is claimed is:

1. An earphone, adapted to be worn on an ear, the earphone comprising:
an acoustical component; and
a wearing component, connected to the acoustical component, the acoustical component and the wearing component jointly form an acoustic chamber, the wearing component comprises a positioning portion, a sound output surface and an acoustic sound outlet, the acoustic sound outlet is located on the sound output surface and communicated with the acoustic chamber,
when the earphone is worn on the ear, the positioning portion extends into the ear and abuts against a cavum conchae of the ear, the sound output surface faces an ear canal of the ear.

2. The earphone as claimed in claim 1, when the earphone is worn on the ear, a tragus of the ear covers the positioning portion.

3. The earphone as claimed in claim 1, wherein an extension axis of the acoustical component is different from an extension axis of the wearing component.

4. The earphone as claimed in claim 1, further comprising an atmosphere sound channel, wherein the atmosphere sound channel comprises a channel body, an atmosphere sound outlet and an atmosphere sound inlet, the wearing component comprises a sound input surface, the atmosphere sound outlet and at least a portion of the atmosphere sound inlet are communicated with the channel body, the atmosphere sound inlet is located on the sound input surface, the atmosphere sound outlet is located on the sound output surface.

5. The earphone as claimed in claim 4, wherein the sound input surface is opposite to the sound output surface and connected to the acoustical component, an orthographic projection of the acoustical component to the wearing component covers the atmosphere sound inlet.

6. The earphone as claimed in claim 4, wherein the wearing component further comprises a connecting surface, the connecting surface is opposite to the sound output surface, the sound input surface is connected to the sound output surface and the connecting surface, the connecting surface is connected to the acoustical component.

7. The earphone as claimed in claim 4, wherein a cross-sectional area of the channel body is less than or equal to an area of the atmosphere sound inlet, and less than or equal to an area of the atmosphere sound outlet.

8. The earphone as claimed in claim 4, wherein a cross-sectional area of the channel body is greater than or equal to an area of the atmosphere sound outlet.

9. The earphone as claimed in claim 4, wherein the wearing component comprises a support structure and a wearing body, the support structure is connected to the wearing body, the acoustical component is connected to the wearing body, the positioning portion is located on the support structure, the atmosphere sound channel is located in the wearing body.

10. The earphone as claimed in claim 4, wherein an area of the acoustic sound outlet is greater than or equal to an area of the atmosphere sound outlet.

11. The earphone as claimed in claim 4, when the earphone is worn on the ear, a gap between the wearing component and the cavum conchae is smaller than a cross-sectional area of the channel body.

12. The earphone as claimed in claim 1, wherein the wearing component comprises a support structure and a wearing body, the support structure is connected to the wearing body, the acoustical component is connected to the wearing body, the positioning portion is located on the support structure.

13. The earphone as claimed in claim 12, wherein the support structure comprises a first portion and a second portion, the first portion is connected to the wearing body, the second portion comprises two opposite ends, the two ends are connected to the first portion, a hollow structure is formed between the second portion and the first portion.

14. The earphone as claimed in claim 1, wherein the wearing component comprises a support structure and a wearing body, the support structure is connected to the wearing body and adapted to connect the ear, the acoustical component is connected to the wearing body, the positioning portion is located on the wearing body.
